(19) United States
(12) Patent Application Publication
(10) Pub. No.: US 2019/0165998 A1
(43) Pub. Date: May 30, 2019

(54) SYSTEM AND METHOD FOR SETTING UP ELECTRONIC CIGARETTE

(71) Applicant: CHANGZHOU JWEI INTELLIGENT TECHNOLOGY CO., LTD., Changzhou (CN)

(72) Inventor: WEI-HUA QIU, ChangZhou (CN)

(21) Appl. No.: 16/262,062

(22) Filed: Jan. 30, 2019

Related U.S. Application Data
(63) Continuation-in-part of application No. PCT/CN2017/097395, filed on Aug. 14, 2017.

(30) Foreign Application Priority Data
Aug. 16, 2016 (CN) 201610671757.2

(51) Int. Cl. H04L 12/24; A24F 47/00; H04L 29/08

(52) U.S. Cl. CPC H04L 41/0806; H04L 67/1097; A24F 47/008

(57) ABSTRACT

A method for setting up an electronic cigarette to suit a particular user includes a cloud server obtaining information from an information database, and sending same to the electronic cigarette, the information being in data packet comprising at least one set of information for setting up the electronic cigarette. The electronic cigarette selects one set of information, such as electrical values of the cigarette, replaceable components and equivalents, and usage habits of a user, and sets up the electronic cigarette accordingly. The setting up method for the electronic cigarette is simplified. The cloud server can establish and extend the information database based on information as to the user operating the cigarette in certain ways, such information being sent to the cloud server by a mobile device. Such information can be issued or reissued by the cloud server as the user requires.

### CROSS-REFERENCE TO RELATED APPLICATIONS

This application claims all benefits accruing under 35 U.S.C. § 119 from China Patent Application No. 201610671757.2, filed on Aug. 16, 2016 in the China National Intellectual Property Administration, the content of which is hereby incorporated by reference. This application is a continuation-in-part under 35 U.S.C. § 120 of international patent application PCT/CN2017/097395 filed Aug. 14, 2017.

### FIELD

The present disclosure relates to electronic cigarettes.

### BACKGROUND

Electronic cigarettes can simulate tobacco smoking, and thus can be substituted for cigarettes and other smoked tobacco products. The electronic cigarette usually includes an atomizer, a controller, and a battery configured to supply electric power to the atomizer. The atomizer heats liquid nicotine or other nicotine substitutes to generate smoke that the user can inhale. When the user inhales, the controller controls the atomizer to operate.

There are many different types and/or models of atomizer, and the type of the battery may also be different. Therefore, a user needs to first operate and adjust the electronic cigarette to find a preferred manner of smoking. Such process may be cumbersome. Therefore, there is room for improvement in the art.

### BRIEF DESCRIPTION OF THE DRAWINGS

Implementations of the present disclosure will now be described, by way of embodiment, with reference to the attached figures.

FIG. 1 is a block diagram of an embodiment of a system for setting up an electronic cigarette according to the present disclosure.

FIG. 2 is a block diagram of a cloud server of the system in FIG. 1.

FIG. 3 is a block diagram of an electronic cigarette of the system in FIG. 1.

FIG. 4 is a flowchart of an embodiment of a method for setting up an electronic cigarette according to the present disclosure.

FIG. 5 is a flowchart of a sub-method for establishing an information database of the method in FIG. 4.

FIG. 6 is a flowchart of another sub-method for establishing an information database of the method in FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Furthermore, the word “controller,” as used hereinafter, refers to logic embodied in hardware or firmware, or to a collection of software instructions, written in a programming language, such as, for example, Java, C, or assembly. One or more software instructions in the controllers may be embedded in firmware. It will be appreciated that controllers may comprise connected logic units, such as gates and flip-flops, and may comprise programmable units, such as programmable gate arrays or processors. The controllers described herein may be implemented as either software and/or hardware controllers and may be stored in any type of non-transitory computer-readable storage medium or other computer storage device.

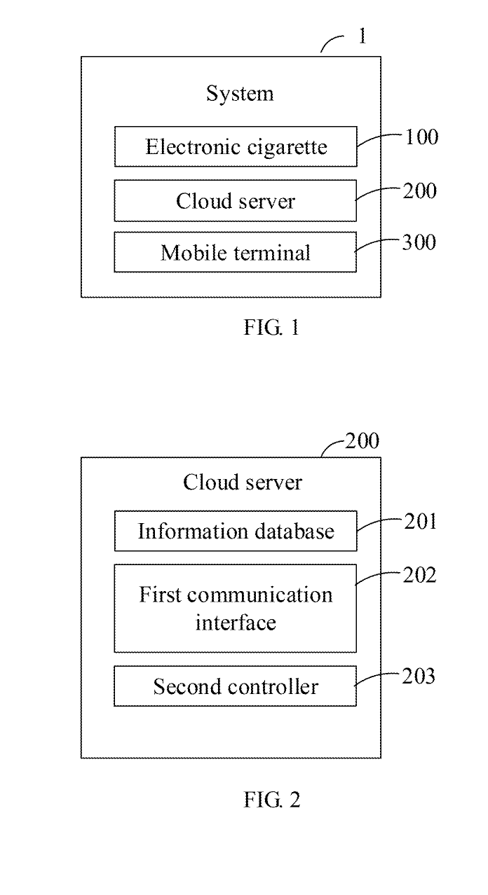

FIG. 1 illustrates an embodiment of a system for setting up an electronic cigarette (system 1). The system 1 includes an electronic cigarette 100 and a cloud server 200.

Referring to FIG. 2, the cloud server 200 includes an information database 201 and a first communication interface 202. The information database 201 stores information in data packet. The information in data packet includes at least one set of information for setting up the electronic cigarette 100. The first communication interface 202 obtains the information in data packet from the information database 201 and sends the obtained information in data packet to the electronic cigarette 100.

In an embodiment, the information in data packet includes, but is not limited to, three sets of information for setting up the electronic cigarette 100.

The first set of information is method for setting up technical parameters of a specific tobacco juice, atomizer, and battery of the electronic cigarette 100, method for setting up working parameters of the electronic cigarette 100, and ranking information of the technical parameters and the working parameters. The technical parameters and the working parameters are stored in the cloud server 200. The ranking information can be ranking different technical parameters and working parameters according to using frequency. The electronic cigarette 100 can select the technical parameters and the working parameters according to the ranking information. For example, the electronic cigarette 100 can select the technical parameters and the working parameters that are ranked on the top. The electronic cigarette 100 can also select the technical parameters and the working parameters that are chosen by the user according to the ranking information.

The second set of information is recommendation information or discount information of tobacco juice with same brand and same taste, and atomizer with same brand, same resistance, and same function, and any combination thereof. Thus, the user can choose a favorite electronic cigarette according to the information, and also can choose the best time to buy a cheap electronic cigarette according to the information.

The third set of information is method for setting up technical parameters of the tobacco juice, the atomizer, and the battery, and working parameters of the electronic cigarette 100, which match usage habit of the user. The technical parameters and the working parameters are calculated according to the usage habits of the user.

The technical parameters of the tobacco juice include, but are not limited to, brand, model, composition, and taste of the tobacco juice. The technical parameters of the atomizer include, but are not limited to, brand and model of the atomizer, and electrical resistance value, material, and number of heat generating element(s) in the atomizer. The technical parameters of the battery include, but are not limited to, brand, model, capacity, type, working temperature, and charging voltage of the battery. The working parameters of the electronic cigarette include working voltage, working power, working temperature, and working duration of the electronic cigarette.

In an embodiment, the system 1 further includes a mobile terminal 300. The first communication interface 202 can send the information in data packet to the electronic cigarette 100 through the mobile terminal 300. The mobile terminal 300 includes, but is not limited to, a smart phone, a smartwatch, a smart wristband, an intelligent television, an intelligent router, a tablet computer, a laptop, and a desktop computer.

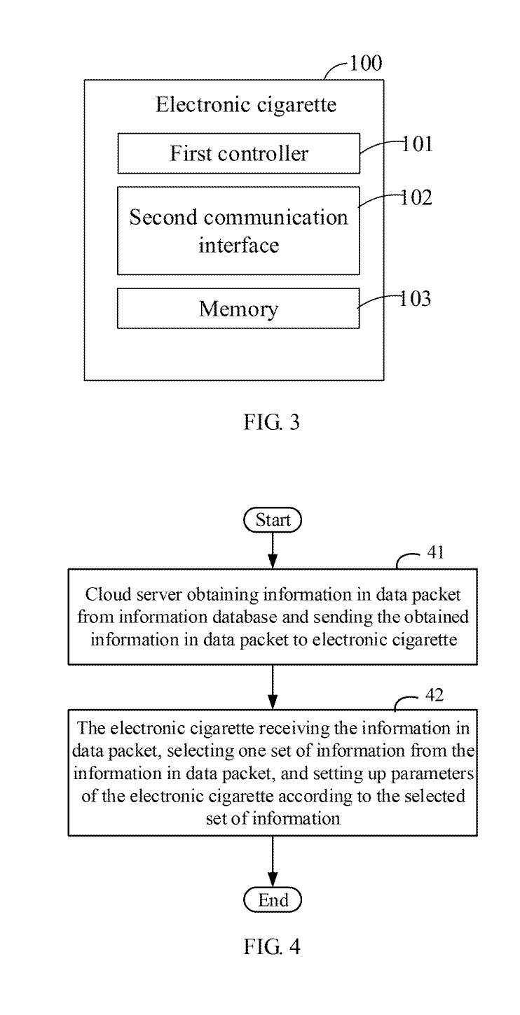

Referring to FIG. 3, the electronic cigarette 100 includes a first controller 101 and a second communication interface 102. The second communication interface 102 receives the information in data packet sent. The first controller 101 selects one set of information from the information in data packet, and sets up the parameters of the electronic cigarette 100 according to the selected set of information.

The parameters of the electronic cigarette 100 include working parameters and technical parameters. The working parameters include working voltage, working power, working temperature, and working duration of the electronic cigarette 100. The technical parameters include technical parameters of the tobacco juice, atomizer, and battery.

In an embodiment, the cloud server 200 further establishes the information database 201. Referring to FIG. 2, the cloud server 200 further includes a second controller 203.

The first controller 101 further records information as to the usage habits of the user (hereinafter, “usage habits information”). The usage habits information includes a working voltage, a working power, and a working temperature of the electronic cigarette 100 set by the user when using the electronic cigarette. The usage habits information also includes the number of inhalations when smoking every day, and a duration for smoking every day. The second communication interface 102 sends the usage habits information to the first communication interface 202.

The first communication interface 202 receives the usage habits information. The second controller 203 stores the received usage habits information to establish the information database 201.

In this embodiment, the second communication interface 102 can send the usage habits information to the first communication interface 202 through the mobile terminal 300. That is, second communication interface 102 sends the usage habits information to the mobile terminal 300. The mobile terminal 300 then sends the usage habits information to the first communication interface 202.

In another embodiment, the electronic cigarette 100 further includes a memory 103.

The memory 103 stores at least the technical parameters of the electronic cigarette 100. The technical parameters include technical parameters of the tobacco juice, atomizer, and battery. The second communication interface 102 sends the stored technical parameters of the electronic cigarette 100 to the first communication interface 202.

The first communication interface 202 receives the technical parameters of the electronic cigarette 100. The second controller 203 stores the received technical parameters of the electronic cigarette 100 to establish and extend the information database 201.

In this embodiment, the second communication interface 102 can send the technical parameters of the electronic cigarette 100 to the first communication interface 202 through the mobile terminal 300. That is, second communication interface 102 sends the technical parameters of the electronic cigarette 100 to the mobile terminal 300. The mobile terminal 300 then sends the technical parameters of the electronic cigarette 100 to the first communication interface 202.

In another embodiment, the memory 103 can be omitted from the electronic cigarette 100 if the electronic cigarette 100 includes a specification or an identification code (such as bar codes or QR codes). The specification and the identification code will include the technical parameters of the cigarette butt, the atomizer, and the battery of the electronic cigarette 100. The identification code can be attached to the electronic cigarette 100 or to an external package or card of the electronic cigarette 100.

In this embodiment, the mobile terminal 300 obtains the technical parameters of the electronic cigarette 100 and sends the technical parameters of the electronic cigarette 100 to the first communication interface 202. The mobile terminal 300 can obtain the technical parameters of the electronic cigarette 100 by scanning the identification code. A user can get to know the technical parameters of the electronic cigarette 100 through its specification, the mobile terminal 300 can also obtain the technical parameters of the electronic cigarette 100 from information input manually by the user.

The first communication interface 202 receives the technical parameters of the electronic cigarette 100. The second controller 203 stores the received technical parameters of the electronic cigarette 100 to establish the information database 201.

In other embodiments, the memory 103 still stores the technical parameters of the electronic cigarette 100. The second communication interface 102 sends a portion of the technical parameters of the electronic cigarette 100 to the mobile terminal 300. The mobile terminal 300 receives the technical parameters, and further obtains the remaining portion of the technical parameters of the electronic cigarette 100 from the memory 103. Then, the mobile terminal 300 combines the received technical parameters and the obtained technical parameters, and sends the combined and complete technical parameters of the electronic cigarette 100 to the first communication interface 202.

FIG. 4 illustrates an embodiment of a method for setting up an electronic cigarette. The method is provided by way of embodiments, as there are a variety of ways to carry out the method. Each block shown in FIG. 4 represents one or more processes, methods, or subroutines, carried out in the example method. The method described below can be carried out using the configurations illustrated in FIGS. 1-3, for example, and various elements of these figures are referenced in explaining example method. Each block shown in FIG. 4 represents one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block 41.

At block 41, the cloud server obtains the information in data packet from the information database and sends the obtained information in data packet to the electronic cigarette.

In an embodiment, the information in data packet includes, but is not limited to, three sets of information for setting up the electronic cigarette.

The first set of information is method for setting up technical parameters of a specific tobacco juice, atomizer, and battery of the electronic cigarette, and method for setting up working parameters of the electronic cigarette, and ranking information of the technical parameters and the working parameters. The technical parameters and the working parameters are stored in the cloud server 200.

The second set of information is recommendation information or discount information of tobacco juice with same brand and same taste, and atomizer with same brand, same resistance, and same function, and any combination thereof.

The third set of information is method for setting up technical parameters of the tobacco juice, the atomizer, and the battery that matches usage habit of the user, and method for setting up working parameters of the electronic cigarette that matches usage habit of the user. The technical parameters and the working parameters are calculated according to the usage habits of the user.

The technical parameters of the tobacco juice include, but are not limited to, brand, model, composition, and taste of the tobacco juice. The technical parameters of the atomizer include, but are not limited to, brand and model of the atomizer, and electrical resistance value, material, and number of heat generating element(s) in the atomizer. The technical parameters of the battery include, but are not limited to, brand, model, capacity, type, working temperature, and charging voltage of the battery. The working parameters of the electronic cigarette include working voltage, working power, working temperature, and working duration of the electronic cigarette.

At block 42, the electronic cigarette receives the information in data packet, selects one set of information from the information in data packet, and sets the parameters of the electronic cigarette according to the selected set of information.

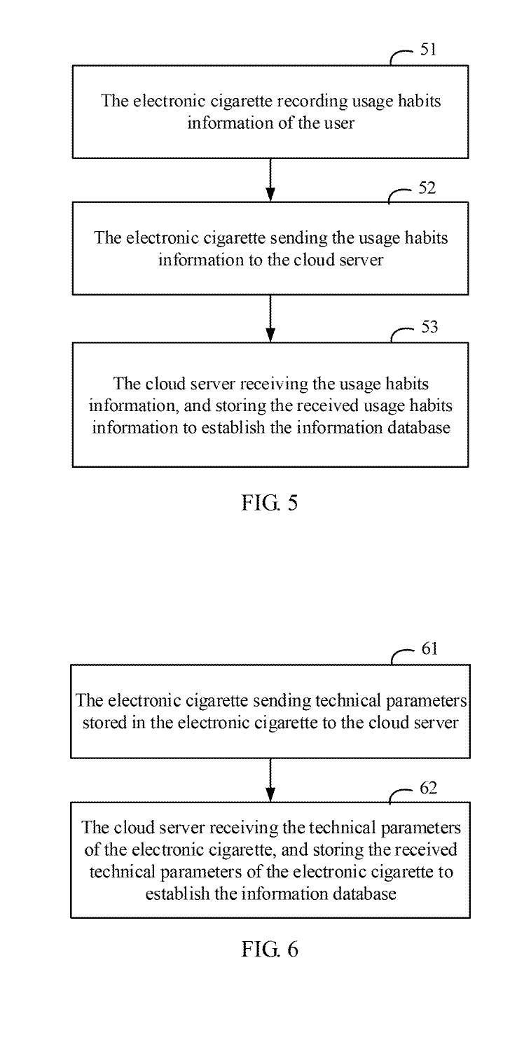

In an embodiment, the method further includes a sub-method for establishing the information database by the cloud server. FIG. 5 illustrates an embodiment of the sub-method for establishing the information database. The method is provided by way of embodiments, as there are a variety of ways to carry out the method. Each block shown in FIG. 5 represents one or more processes, methods, or subroutines, carried out in the example method. The method described below can be carried out using the configurations illustrated in FIGS. 1-3, for example, and various elements of these figures are referenced in explaining example method. Each block shown in FIG. 5 represents one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block 51.

At block 51, the electronic cigarette records usage habits information of the user. The usage habits information includes a working voltage, a working power, and a working temperature of the electronic cigarette 100 set by the user when using the electronic cigarette, and a number of inhalations when smoking and a duration for smoking every day.

At block 52, the electronic cigarette sends the usage habits information to the cloud server.

In this embodiment, the electronic cigarette can send the usage habits information to the cloud server through the mobile terminal.

At block 53, the cloud server receives the usage habits information, and stores the received usage habits information to establish the information database.

FIG. 6 illustrates another embodiment of the sub-method for establishing the information database. The method is provided by way of embodiments, as there are a variety of ways to carry out the method. Each block shown in FIG. 6 represents one or more processes, methods, or subroutines, carried out in the example method. The method described below can be carried out using the configurations illustrated in FIGS. 1-3, for example, and various elements of these figures are referenced in explaining example method. Each block shown in FIG. 6 represents one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block 61.

At block 61, the electronic cigarette sends the technical parameters stored in the electronic cigarette to the cloud server. The technical parameters include technical parameters of the tobacco juice, atomizer, and battery.

In this embodiment, the electronic cigarette can send the technical parameters of the electronic cigarette to the cloud server through the mobile terminal.

At block 62, the cloud server receives the technical parameters of the electronic cigarette, and stores the received technical parameters of the electronic cigarette to establish the information database.

With the above configuration, the electronic cigarette can obtain the information in data packet from the cloud server and set up the electronic cigarette up accordingly. Thus, the setup method for the electronic cigarette is simplified. Furthermore, the cloud server can establish and extend an information database after analysis and calculation. The information database is capable of being updated and modified, the cloud server can send information as to updates and modifications as data packet to the cloud server in real time. Thus, the user experience can be improved.

The embodiments shown and described above are only examples. Therefore, many commonly-known features and details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A method for setting up electronic cigarette applied between an electronic cigarette and a cloud server, the method comprising:
the cloud server obtaining an information in data packet from an information database, and sending the obtained information in data packet to the electronic cigarette, the information in data packet comprising at least one set of information for setting the electronic cigarette; and
the electronic cigarette receiving the information in data packet, selecting one set of information from the information in data packet, and setting parameters of the electronic cigarette according to the selected set of information.

2. The method of claim 1, wherein the obtained information in data packet is sent to the electronic cigarette through a mobile terminal.

3. The method of claim 1, wherein before the cloud server obtaining the information in data packet from the information database, the method further comprises:
the electronic cigarette recording information as to usage habits of a user;
the electronic cigarette sending the usage habits information to the cloud server;
the cloud server receiving the usage habits information, and storing the received usage habits information to establish the information database.

4. The method of claim 3, the usage habits information is sent to the cloud server directly by the electronic cigarette or through a mobile terminal.

5. The method of claim 1, wherein before the cloud server obtaining the information in data packet from the information database, the method further comprises:
the electronic cigarette sending technical parameters stored in the electronic cigarette to the cloud server;
the cloud server receiving the technical parameters of the electronic cigarette, and storing the received technical parameters of the electronic cigarette to establish the information database.

6. The method of claim 5, wherein the technical parameters of the electronic cigarette are sent to the cloud server directly by the electronic cigarette or through a mobile terminal.

7. A system for setting up electronic cigarette, comprising:
a cloud server comprising:
an information database storing an information in data packet, the information in data packet comprising at least one set of information for setting an electronic cigarette; and
a first communication interface; and
an electronic cigarette comprising:
a second communication interface, the first communication interface configured to obtain the information in data packet from the information database and send the obtained information in data packet to the second communication interface; the second communication interface configured to receive the information in data packet; and
a first controller configured to select one set of information from the information in data packet, and set parameters of the electronic cigarette according to the selected set of information.

8. The system of claim 7, further comprising a mobile terminal, wherein the obtained information in data packet is sent to the second communication interface through the mobile terminal.

9. The system of claim 7, wherein the cloud server further comprises a second controller;
the first controller is further configured to record information as to usage habits of a user, the second communication interface is further configured to send the usage habits information to the first communication interface;
the first communication interface is further configured to receive the usage habits information;
the second controller is configured to store the received usage habits information to establish the information database.

10. The system of claim 9, further comprising a mobile terminal, wherein the second communication interface directly sends the usage habits information to the first communication interface, or sends the usage habits information to the first communication interface through the mobile terminal.

11. The system of claim 7, wherein the electronic cigarette further comprises a memory, the cloud server further comprises a second controller;
the memory stores technical parameters of the electronic cigarette;
the first controller is further configured to send the technical parameters of the electronic cigarette stored in the memory to the first communication interface;
the first communication interface is further configured to receive the technical parameters of the electronic cigarette;
the second controller is configured to store the technical parameters of the electronic cigarette to establish the information database.

12. The system of claim 11, further comprising a mobile terminal, wherein the second communication interface directly sends the technical parameters of the electronic cigarette to the first communication interface, or sends the technical parameters of the electronic cigarette to the first communication interface through the mobile terminal.

13. The system of claim 7, further comprising a mobile terminal, wherein the cloud server further comprises a second controller;
the mobile terminal is configured to obtain technical parameters of the electronic cigarette and send the technical parameters of the electronic cigarette to the first communication interface;
the first communication interface is further configured to receive the technical parameters of the electronic cigarette;
the second controller is configured to store the technical parameters of the electronic cigarette to establish the information database.

14. The system of claim 13, wherein the electronic cigarette further comprises a specification or an identification code, the specification and the identification code comprises the technical parameters, the mobile terminal obtains the technical parameters of the electronic cigarette by scanning the identification code, or by information from the specification manually input by a user.

15. The system of claim 7, further comprising a mobile terminal, wherein the electronic cigarette further comprises a memory, the cloud server further comprises a second controller;
the memory stores technical parameters of the electronic cigarette;
the first controller is further configured to send a portion of the technical parameters of the electronic cigarette stored in the memory to the first communication interface;
the mobile terminal is configured to receive the portion of the technical parameters, and obtain a remaining portion of the technical parameters of the electronic cigarette stored in the memory, combine the received portion of the technical parameters and the obtained portion of the technical parameters, and send the combined technical parameters of the electronic cigarette to the first communication interface;
the first communication interface is further configured to receive the combined technical parameters of the electronic cigarette;
the second controller is configured to store the combined technical parameters of the electronic cigarette to establish the information database.

16. The system of claim 15, wherein the electronic cigarette further comprises a specification or an identification code, the specification and the identification code comprises the technical parameters, the mobile terminal obtains the technical parameters of the electronic cigarette by scanning the identification code, or by information from the specification manually input by a user.
